(19) United States
(12) Patent Application Publication
(10) Pub. No.: US 2015/0274977 A1
(43) Pub. Date: Oct. 1, 2015

(54) SOLID PIGMENT PREPARATIONS CONTAINING WATER-SOLUBLE SURFACE-ACTIVE ADDITIVES AND ANTI-OXIDANTS

(71) Applicant: BASF SE, Ludwigshafen (DE)

(72) Inventors: Hansulrich REISACHER, Maxdorf (DE); Uwe Mauthe, Mannheim (DE); Gerhard Wagenblast, Wachenheim (DE)

(73) Assignee: BASF SE, Ludwigshafen (DE)

(21) Appl. No.: 14/673,992

(22) Filed: Mar. 31, 2015

Related U.S. Application Data
(63) Continuation of application No. 11/995,129, filed on Jan. 9, 2008, now abandoned.

(30) Foreign Application Priority Data
Jul. 25, 2005 (DE) 102005035253.7

(51) Int. Cl. C09C 1/24; C09C 1/00

(52) U.S. Cl. CPC C09C 1/24; C09C 1/0006; C01P 2006/12

(57) ABSTRACT

Solid pigment preparations comprising as essential constituents
(A) 45% to 90% by weight of at least one color-conferring component comprising
(A1) 5% to 100% by weight of at least one pigment and
(A2) 0% to 95% by weight of at least one filler without self color,
(B) 5% to 50% by weight of at least one water-soluble surface-active additive from the group of alkylene oxide group containing additives (B1) and alkylene oxide group free additives (B2), the alkylene oxide group containing additive (B1) comprising at least 5% by weight of the pigment preparation, and
(C) 0.1% to 5% by weight of an antioxidant
   and also production and use of the pigment preparations for coloration of macromolecular organic or inorganic materials and also of plastics materials.

This application is a continuation of U.S. application Ser. No. 11/995,129 filed Jan. 9, 2008, which is a National Stage of PCT/EP2006/064267 filed Jul. 14, 2006, both of which are incorporated herein by reference. This application also claims the benefit of DE 102005035253.7 filed Jul. 25, 2005.

### DESCRIPTION

The present invention relates to solid pigment preparations comprising as essential constituents
(A) 45% to 90% by weight of at least one color-conferring component comprising
(A1) 5% to 100% by weight of at least one pigment and
(A2) 0% to 95% by weight of at least one filler without self color,
(B) 5% to 50% by weight of at least one water-soluble surface-active additive from the group of alkylene oxide group containing additives (B1) and alkylene oxide group free additives (B2), the alkylene oxide group containing additive (B1) comprising at least 5% by weight of the pigment preparation, and
(C) 0.1% to 5% by weight of an antioxidant.

The present invention further relates to the production of these pigment preparations and their use for coloration of macromolecular organic and inorganic materials and also of plastics.

Solid pigment preparations that, like liquid pigment preparations, are simple to disperse in liquid application media by stirring or shaking, i.e., pigment preparations possessing stir-in characteristics, are increasingly of importance.

WO-A-03/64540, 03/66743, 04/00903, 04/29159, 04/46251 and 04/50770 and prior German patent applications 102005005846.9 and 102005005975.9 describe pigment preparations comprising nonionic surface-active additives based on polyethers and/or anionic water-soluble surface-active additives based on acidic esters of these polyethers, on polymers of ethylenically unsaturated carboxylic acids and/or on polyurethanes and also fillers and possessing this stir-in performance.

An essential step in the production of solid pigment preparations is the drying of the aqueous suspensions generated when the pigment is finely dispersed and all ingredients are mixed. However, alkylene oxide group containing surface-active additives tend to decompose at drying temperatures as low as >80° C. in the presence of inorganic pigments based on iron oxides in particular. Their decomposition manifests itself in the temperature of the drying material increasing abruptly by up to 300° C. and therefore constitutes a safety risk.

It is an object of the present invention to remedy this problem and provide solid pigment preparations which shall not only possess altogether advantageous performance characteristics but also be technically safe to produce.

We have found that this object is achieved by pigment preparations comprising as essential constituents
(A) 45% to 90% by weight of at least one color-conferring component comprising
(A1) 5% to 100% by weight of at least one pigment and
(A2) 0% to 95% by weight of at least one filler without self color,
(B) 5% to 50% by weight of at least one water-soluble surface-active additive from the group of alkylene oxide group containing additives (B1) and alkylene oxide group free additives (B2), the alkylene oxide group containing additive (B1) comprising at least 5% by weight of the pigment preparation, and
(C) 0.1% to 5% by weight of an antioxidant.

The present invention also provides a process for producing the pigment preparations, the process comprising first wet-comminuting said pigment (A1) in aqueous suspension comprising said antioxidant (C) and some or all of additive (B), if desired adding said filler (A2) to said suspension before or after said wet-comminuting of said pigment (A1) and then drying said suspension, if appropriate after the rest of said additive (B) has been added.

The present invention further provides a process for coloration of macromolecular organic or inorganic materials, which comprises incorporating the pigment preparations in said materials by stirring or shaking.

The present invention finally provides a process for coloration of plastics materials, which comprises incorporating these pigment preparations in said plastics materials by extruding, rolling, kneading or milling.

The pigment preparations of the present invention comprise as essential constituents a color-conferring component (A), a water-soluble surface-active additive (B) and an antioxidant (C).

The color-conferring component (A) is based on at least one pigment (A1) which may be present in combination with at least one filler (A2) without self color.

Pigment (A1) in the pigment preparations of the present invention may comprise organic or inorganic pigments. It will be appreciated that the pigment preparations may also comprise mixtures of various organic or various inorganic pigments or mixtures of organic and inorganic pigments.

The pigments are present in finely divided form. Accordingly, their average particle size is typically in the range from 0.1 to 5 urn.

The inorganic pigments used can be chromatic, black and white pigments (color pigments) and also luster pigments. Typical organic pigments are chromatic and black pigments.

Examples of suitable inorganic pigments are:
white pigments:
   titanium dioxide (C.I. Pigment White 6), zinc white, pigment grade zinc oxide; zinc sulfide, lithopone;
   black pigments: iron oxide black (C.I. Pigment Black 11), iron manganese black, spinel black (C.I. Pigment Black 27); carbon black (C.I. Pigment Black 7);
   chromatic pigments: chromium oxide, chromium oxide hydrate green; chrome green
   (C.I. Pigment Green 48); cobalt green (C.I. Pigment Green 50);
   ultramarine green;
   cobalt blue (C.I. Pigment Blue 28 and 36; C.I. Pigment Blue 72);
   ultramarine blue; manganese blue;
   ultramarine violet; cobalt violet and manganese violet;
   red iron oxide (C.I. Pigment Red 101); cadmium sulfoselenide (C.I. Pigment Red 108); cerium sulfide (C.I. Pigment Red 265);
   molybdate red (C.I. Pigment Red 104); ultramarine red;
   brown iron oxide (C.I. Pigment Brown 6 and 7), mixed brown, spinel phases and corundum phases (C.I. Pigment Brown 29, 31, 33, 34, 35, 37, 39 and 40), chromium titanium yellow (C.I. Pigment Brown 24), chrome orange;
   cerium sulfide (C.I. Pigment Orange 75);
   yellow iron oxide (C.I. Pigment Yellow 42); nickel titanium yellow (C.I. Pigment Yellow 53; C.I. Pigment Yellow 157, 158, 159, 160, 161, 162, 163, 164 and 189); chromium titanium yellow; spinel phases (C.I. Pigment Yellow 119); cadmium sulfide and cadmium zinc sulfide (C.I. Pigment Yellow 37 and 35); chrome yellow (C.I. Pigment Yellow 34); bismuth vanadate (C.I. Pigment Yellow 184).

Luster pigments are platelet-shaped pigments having a monophasic or polyphasic construction whose color play is marked by the interplay of interference, reflection and absorption phenomena. Examples are aluminum platelets and aluminum, iron oxide and mica platelets bearing one or more coats, especially of metal oxides.

Examples of suitable organic pigments are:
monoazo pigments:
   C.I. Pigment Brown 25;
   C.I. Pigment Orange 5, 13, 36, 38, 64 and 67;
   C.I. Pigment Red 1, 2, 3, 4, 5, 8, 9, 12, 17, 22, 23, 31, 48:1, 48:2, 48:3, 48:4, 49, 49:1, 51:1, 52:1, 52:2, 53, 53:1, 53:3, 57:1, 58:2, 58:4, 63, 112, 146, 148, 170, 175, 184, 185, 187, 191:1, 208, 210, 245, 247 and 251;
   C.I. Pigment Yellow 1, 3, 62, 65, 73, 74, 97, 120, 151, 154, 168, 181, 183 and 191;
   C.I. Pigment Violet 32;
   disazo pigments: C.I. Pigment Orange 16, 34, 44 and 72;
   C.I. Pigment Yellow 12, 13, 14, 16, 17, 81, 83, 106, 113, 126, 127, 155, 174, 176, 180 and 188;
disazo condensation pigments:
   C.I. Pigment Yellow 93, 95 and 128;
   C.I. Pigment Red 144, 166, 214, 220, 221, 242 and 262;
   C.I. Pigment Brown 23 and 41;
anthanthrone pigments:
   C.I. Pigment Red 168;
anthraquinone pigments:
   C.I. Pigment Yellow 147, 177 and 199;
   C.I. Pigment Violet 31;
anthrapyrimidine pigments:
   C.I. Pigment Yellow 108;
quinacridone pigments:
   C.I. Pigment Orange 48 and 49;
   C.I. Pigment Red 122, 202, 206 and 209;
   C.I. Pigment Violet 19;
quinophthalone pigments:
   C.I. Pigment Yellow 138;
diketopyrrolopyrrole pigments:
   C.I. Pigment Orange 71, 73 and 81;
   C.I. Pigment Red 254, 255, 264, 270 and 272;
dioxazine pigments:
   C.I. Pigment Violet 23 and 37;
   C.I. Pigment Blue 80;
flavanthrone pigments:
   C.I. Pigment Yellow 24;
indanthrone pigments:
   C.I. Pigment Blue 60 and 64;
isoindoline pigments:
   C.I. Pigment Orange 61 and 69;
   C.I. Pigment Red 260;
   C.I. Pigment Yellow 139 and 185;
isoindolinone pigments:
   C.I. Pigment Yellow 109, 110 and 173;
isoviolanthrone pigments:
   C.I. Pigment Violet 31;
metal complex pigments:
   C.I. Pigment Red 257;
   C.I. Pigment Yellow 117, 129, 150, 153 and 177;
   C.I. Pigment Green 8;
perinone pigments:
   C.I. Pigment Orange 43;
   C.I. Pigment Red 194;
perylene pigments:
   C.I. Pigment Black 31 and 32;
   C.I. Pigment Red 123, 149, 178, 179, 190 and 224;
   C.I. Pigment Violet 29;
phthalocyanine pigments:
   C.I. Pigment Blue 15, 15:1, 15:2, 15:3, 15:4, 15:6 and 16;
   C.I. Pigment Green 7 and 36;
pyranthrone pigments:
   C.I. Pigment Orange 51;
   C.I. Pigment Red 216;
pyrazoloquinazolone pigments:
   C.I. Pigment Orange 67;
   C.I. Pigment Red 251;
thioindigo pigments:
   C.I. Pigment Red 88 and 181;
triarylcarbonium pigments:
   C.I. Pigment Blue 1, 61 and 62;
   C.I. Pigment Green 1;
   C.I. Pigment Red 81, 81:1 and 169;
   C.I. Pigment Violet 1, 2, 3 and 27;
   C.I. Pigment Black 1 (aniline black);
   C.I. Pigment Yellow 101 (aldazine yellow);
   C.I. Pigment Brown 22.

Inorganic pigments are of particular importance as color-conferring component (A1) for the pigment preparations of the present invention. Particularly suitable inorganic pigments are the pigments based on an iron oxide, especially iron oxide black (C.I. Pigment Black 11) and also iron oxide red (C.I. Pigment Red 101) and iron oxide yellow (C.I. Pigment Yellow 42), which can both be used in opaque or transparent form.

The pigment preparations of the present invention may comprise the pigment (A1) in combination with a filler (A2), in particular an inorganic filler (A2), without self color.

These colorless or white fillers (A2) generally have a refractive index 1.7. For example, the refractive index is 1.55 for chalk, 1.64 for barite, 1.56 for kaolin, 1.57 for talc, 1.58 for mica and 1.55 for silicates.

The fillers (A2) like the pigments (A1) are insoluble in the application medium and are selected in particular from the following chemical classes (not only products of natural origin but also products of synthetic origin being recited by way of example):
oxides and hydroxides:
natural: aluminum oxide and magnesium oxide;
synthetic: aluminum hydroxide and magnesium hydroxide;
silicon dioxide and silicates:
natural: quartz, christobalite, kieselguhr, talc, kaolin, diatomaceous earth, mica, wollastonite and feldspar;
synthetic: fumed silica, precipitated silica, aluminosilicates and calcined aluminosilicates:
carbonates:
natural: carbonates of calcium and of magnesium, such as calcite, chalk, dolomite and magnesite;
synthetic: precipitated calcium carbonate;
sulfates:
natural: sulfates of barium and of calcium, such as barite and gypsum; synthetic: precipitated barium sulfate.

The fillers (A2) may have a wide variety of particulate shapes. The particles may be spheres, cubes, platelets or fibers for example. Natural-based fillers typically have particle sizes in the range from about 1 to 300 μm. For example, commercial products based on natural chalk have a d₅₀ value which is generally in the range from 1 to 160 μm. Particle sizes below 1 μm are generally only present in the case of fillers produced synthetically, in particular by precipitation.

Fillers (A2) preferred for the pigment preparations of the present invention are carbonates and sulfates, and natural and precipitated chalk and also barium sulfate are particularly preferred. These products are commercially available, for example as Omyacarb® and Omyalite® (from Omya) and Blanc fixe (from Sachtleben).

The color-conferring component (A) of the pigment preparations according to the present invention comprises 5% to 100% by weight of pigment (A1) and 0% to 95% by weight of filler (A2). When fillers (A2) are a constituent of the color-conferring component (A), their minimum content is generally 20% by weight, based on component (A).

Component (B) of the pigment preparations according to the present invention comprises at least one alkylene oxide group containing water-soluble surface-active additive (B1) or a combination of said additive (B1) with a further water-soluble additive
(B2) comprising no alkylene oxide groups. In either case, the alkylene oxide group comprising additive (B1) content of the pigment preparations according to the present invention is at least 5% by weight.

Useful additives (B1) include in particular nonionic additives based on polyethers (B11) and also anionic additives based on acidic phosphoric, phosphonic, sulfuric and/or sulfonic esters of these polyethers (B12) and on alkoxylation products of polymers of ethylenically unsaturated carboxylic acids (B13). The additives (B11) and (B13) are preferred additives (B1).

As well as unmixed polyalkylene oxides, preferably C₂-C₄-alkylene oxides and phenyl-substituted C₂-C₄-alkylene oxides, especially polyethylene oxides, polypropylene oxides and poly(phenylethylene oxide)s, it is in particular block copolymers, especially polymers having polypropylene oxide and polyethylene oxide blocks or poly(phenylethylene oxide) and polyethylene oxide blocks, and also random copolymers of these alkylene oxides which are suitable for use as nonionic additives (B11).

These polyalkylene oxides are preparable by polyaddition of alkylene oxides onto starter molecules, for example onto saturated or unsaturated aliphatic and aromatic alcohols, saturated or unsaturated aliphatic and aromatic amines, saturated or unsaturated aliphatic carboxylic acids and carboxamides and also aromatic carboxamides and sulfonamides. The aromatic starter molecules may be substituted by C₁-C₂₀-alkyl or C₇-C₃₀-aralkyl. It is customary to use from 1 to 300 mol and preferably from 3 to 150 mol of alkylene oxide per mole of starter molecule, although in the case of aromatic starter molecules the alkylene oxide quantities range in particular from 2 to 100 mol, preferably from 5 to 50 mol and especially from 10 to 30 mol. The polyaddition products may have a terminal OH group or be end group capped, for example as a C₁-C₆-alkyl ether.

Suitable aliphatic alcohols comprise in general from 6 to 26 carbon atoms and preferably from 8 to 18 carbon atoms and can have an unbranched, branched or cyclic structure. Examples are octanol, nonanol, decanol, isodecanol, undecanol, dodecanol, 2-butyloctanol, tridecanol, isotridecanol, tetradecanol, pentadecanol, hexadecanol (cetyl alcohol), 2-hexyldecanol, heptadecanol, octadecanol (stearyl alcohol), 2-heptyl-undecanol, 2-octyldecanol, 2-nonyltridecanol, 2-decyltetradecanol, oleyl alcohol and 9-octadecanol and also mixtures of these alcohols, such as C₈/C₁₀, C₁₃/C₁₅ and C₁₆/C₁₈ alcohols, and cyclopentanol and cyclohexanol. Of particular interest are the saturated and unsaturated fatty alcohols obtained from natural raw materials by lipolysis and reduction and the synthetic fatty alcohols from the oxo process. The alkylene oxide adducts with these alcohols typically have average molecular weights Mₙ from 200 to 5000.

Examples of the abovementioned aromatic alcohols include not only unsubstituted phenol and α- and β-naphthol but also the alkyl-substituted products, which are substituted in particular by C₁-C₁₂-alkyl, preferably C₄-C₁₂-alkyl or C₁-C₄-alkyl, and the aralkyl-substituted products, in particular C₇-C₃₀-aralkyl-substituted phenol, such as hexylphenol, heptylphenol, octylphenol, nonylphenol, isononylphenol, undecylphenol, dodecylphenol, di- and tributylphenol and dinonylphenol, and also bisphenol A and its reaction products with styrene, in particular bisphenol A substituted by a total of 4 phenyl-1-ethyl radicals in the ortho positions to the two OH groups.

Suitable aliphatic amines correspond to the abovementioned aliphatic alcohols. Again of particular importance here are the saturated and unsaturated fatty amines which preferably have from 14 to 20 carbon atoms. Examples of aromatic amines are aniline and its derivatives.

Useful aliphatic carboxylic acids include especially saturated and unsaturated fatty acids which preferably comprise from 14 to 20 carbon atoms and fully hydrogenated, partially hydrogenated and unhydrogenated resin acids and also polyfunctional carboxylic acids, for example dicarboxylic acids, such as maleic acid.

Suitable carboxamides are derived from these carboxylic acids.

As well as alkylene oxide adducts with monofunctional amines and alcohols it is alkylene oxide adducts with at least bifunctional amines and alcohols which are of very particular interest.

The at least bifunctional amines preferably have from 2 to 5 amine groups and conform in particular to the formula H₂N—(R¹—NR²)ₙ—H (R¹: C₂-C₆-alkylene; R²: hydrogen or C₁-C₆-alkyl; n: 1-5). Specific examples are: ethylenediamine, diethylenetriamine, triethylene-tetramine, tetraethylenepentamine, 1,3-propylenediamine, dipropylenetriamine, 3-amino-1-ethyleneaminopropane, hexamethylenediamine, dihexamethylenetriamine, 1,6-bis(3-aminopropylamino)hexane and N-methyldipropylenetriamine, of which hexamethylenediamine and diethylenetriamine are more preferable and ethylenediamine is most preferable.

These amines are preferably reacted first with propylene oxide and then with ethylene oxide. The ethylene oxide content of the block copolymers is typically about 10% to 90% by weight.

The average molecular weights Mₙ of the block copolymers based on polyfunctional amines are generally in the range from 1000 to 40 000 and preferably in the range from 1500 to 30 000.

The at least bifunctional alcohols preferably have from two to five hydroxyl groups. Examples are C₂-C₆-alkylene glycols and the corresponding di- and polyalkylene glycols, such as ethylene glycol, 1,2-propylene glycol, 1,3-propylene glycol, 1,2-butylene glycol, 1,4-butylene glycol, 1,6-hexylene glycol, dipropylene glycol and polyethylene glycol, glycerol and pentaerythritol, of which ethylene glycol and polyethylene glycol are more preferable and propylene glycol and dipropylene glycol are most preferable.

Particularly preferred alkylene oxide adducts with at least bifunctional alcohols have a central polypropylene oxide block, i.e. are based on a propylene glycol or polypropylene glycol which is initially reacted with further propylene oxide and then with ethylene oxide. The ethylene oxide content of the block copolymers is typically in the range from 10% to 90% by weight.

The average molecular weights Mₙ of the block copolymers based on polyhydric alcohols are generally in the range from 1000 to 20 000 and preferably in the range from 1000 to 15 000.

Such alkylene oxide block copolymers are known and commercially available for example under the names of Tetronic®, Pluronic® and Pluriol® (BASF), Atlas® (Uniquema), Emulgator WN and 386 (Lanxess) and also Soprophor® (Rhodia).

The anionic additives (B12) are based on the reaction products of these polyethers (B11) with phosphoric acid, phosphorus pentoxide and phosphonic acid on the one hand and sulfuric acid and sulfonic acid on the other. In the reaction, the polyethers are converted into the corresponding phosphoric mono- or diesters and phosphonic esters on the one hand and the sulfuric monoesters and sulfonic esters on the other. These acidic esters are preferably present in the form of water-soluble salts, in particular as alkali metal salts, especially sodium salts, and ammonium salts, but can also be used in the form of the free acids.

Preferred phosphates and phosphonates are derived especially from alkoxylated, in particular ethoxylated, fatty and oxo alcohols, alkylphenols, fatty amines, fatty acids and resin acids, and preferred sulfates and sulfonates are based in particular on alkoxylated, especially ethoxylated, fatty alcohols, alkylphenols and amines, including polyfunctional amines, such as hexamethylenediamine.

Such anionic surface-active additives are known and commercially available for example under the names of Nekal® (BASF), Tamol® (BASF), Crodafos® (Croda), Rhodafac® (Rhodia), Maphos® (BASF), Texapon® (Cognis), Empicol® (Albright & Wilson), Matexil® (ICI), Soprophor® (Rhodia) and Lutensit® (BASF).

The anionic additives (B13) are the alkoxylation products of polymers of ethylenically unsaturated carboxylic acids.

In nonalkoxylated form, the carboxylic acid polymers are also useful as anionic water-soluble surface-active additives (B21). The additive classes (B13) and (B21) will therefore be now described together.

The unsaturated carboxylic acid polymers which serve as a basis for the additives (B21) and (B13) are in particular homo- and copolymers of ethylenically unsaturated monocarboxylic acids and/or ethylenically unsaturated dicarboxylic acids, which may each further comprise interpolymerized vinyl monomers comprising no acid function, and salts thereof.

As examples of carboxyl-containing monomers and of vinyl monomers there may be mentioned:
acrylic acid, methacrylic acid and crotonic acid;
maleic acid, maleic anhydride, maleic monoesters, maleic monoamides, reaction products of maleic acid with diamines, which may be oxidized to form derivatives comprising amine oxide groups, and fumaric acid, of which maleic acid, maleic anhydride and maleic monoamides are preferred;
vinylaromatics, such as styrene, methylstyrene and vinyltoluene; ethylene, propylene, isobutene, diisobutene and butadiene; vinyl ethers, such as polyethylene glycol monovinyl ether; vinyl esters of linear or branched monocarboxylic acids, such as vinyl acetate and vinyl propionate; alkyl esters and aryl esters of ethylenically unsaturated monocarboxylic acids, in particular acrylic and methacrylic esters, such as methyl acrylate, ethyl acrylate, propyl acrylate, isopropyl acrylate, butyl acrylate, pentyl acrylate, hexyl acrylate, 2-ethylhexyl acrylate, nonyl acrylate, lauryl acrylate, hydroxyethyl acrylate, methyl methacrylate, ethyl methacrylate, propyl methacrylate, isopropyl methacrylate, butyl methacrylate, pentyl methacrylate, hexyl methacrylate, 2-ethylhexyl methacrylate, nonyl methacrylate, lauryl methacrylate and hydroxyethyl methacrylate and also phenyl acrylate, phenyl methacrylate, naphthyl acrylate, naphthyl methacrylate, benzyl acrylate and benzyl methacrylate; dialkyl esters of ethylenically unsaturated dicarboxylic acids, such as dimethyl maleate, diethyl maleate, dipropyl maleate, diisopropyl maleate, dibutyl maleate, dipentyl maleate, dihexyl maleate, di-2-ethylhexyl maleate, dinonyl maleate, dilauryl maleate, di-2-hydroxyethyl maleate, dimethyl fumarate, diethyl fumarate, dipropyl fumarate, diisopropyl fumarate, dibutyl fumarate, dipentyl fumarate, dihexyl fumarate, di-2-ethylhexyl fumarate, dinonyl fumarate, dilauryl fumarate, di-2-hydroxyethyl fumarate; vinylpyrrolidone; acrylonitrile and methacrylonitrile; of which styrene, isobutene, diisobutene, acrylic esters and polyethylene glycol monovinyl ether are preferred.

Polyacrylic acids in particular are to be mentioned as examples of preferred homo-polymers of these monomers.

The copolymers of the monomers mentioned may be constructed of two or more and in particular three different monomers. The copolymers may be random, alternating, block or graft. Preferred copolymers are styrene-acrylic acid, acrylic acid-maleic acid, acrylic acid-methacrylic acid, butadiene-acrylic acid, isobutene-maleic acid, diisobutene-maleic acid and styrene-maleic acid copolymers, which may each comprise acrylic esters and/or maleic esters as additional monomeric constituents.

Preferably, the carboxyl groups of nonalkoxylated homo- and copolymers are wholly or partly present in salt form in order that solubility in water may be ensured. The alkali metal salts, such as sodium and potassium salts, and the ammonium salts are suitable for example.

The nonalkoxylated polymeric additives (B21) will typically have average molecular weights M_{w} in the range from 900 to 250 000. The molecular weight ranges particularly suitable for the individual polymers depend on their composition, of course. The molecular weight data which follow for various polymers are given by way of example: polyacrylic acids: M_{w} from 900 to 250 000; styrene-acrylic acid copolymers: M_{w} from 1000 to 50 000; acrylic acid-methacrylic acid copolymers: M_{w} from 1000 to 250 000; acrylic acid-maleic acid copolymers: M_{w} from 2000 to 70 000.

The alkoxylation products (B13) of these homo- and copolymers are formed by partial to (if possible) complete esterification with polyether alcohols. The degree of esterification of these polymers is generally in the range from 30 to 80 mol %.

Useful polyether alcohols for the esterification are in particular the polyether alcohols themselves, preferably polyethylene glycols and polypropylene glycols, and also their unilaterally end-capped derivatives, in particular the corresponding monoethers, such as monoaryl ethers, for example monophenyl ethers, and in particular mono-C₁-C₂₆-alkyl ethers, for example ethylene and propylene glycols etherified with fatty alcohols, and the polyetheramines which are preparable for example by conversion of a terminal OH group of the corresponding polyether alcohols or by polyaddition of alkylene oxides onto preferably primary aliphatic amines. Preference here is given to polyethylene glycols, polyethylene glycol monoethers and polyetheramines. The average molecular weights Mₙ of the polyether alcohols used and of their derivatives is typically in the range from 200 to 10 000.

Specific surface-active properties can be achieved for the additives (B13) or (B21) by varying the ratio of polar to apolar groups.

The anionic surface-active additives (B13) or (B21) are likewise known and commercially available, for example under the names Sokalan® (BASF), Joncryl® (Johnson Polymer), Alcosperse® (Alco), Geropon® (Rhodia), Good-Rite® (Goodrich), Neoresin® (Avecia), Orotan® and Morez® (Rohm & Haas), Disperbyk® (Byk) and also Tegospers® (Goldschmidt).

Anionic additives based on polyurethanes (B22) are useful as water-soluble surface-active additives (B2) as well as the nonalkoxylated carboxylic acid polymers (B21) which are preferred for use as additive (B2).

For the purposes of the present invention, the term “polyurethane” shall comprehend not just the pure reaction products of polyfunctional isocyanates (B22a) with isocyanate-reactive hydroxyl-comprising organic compounds (B22b), but also these reaction products after additional functionalization through the addition of further isocyanate-reactive compounds, examples being carboxylic acids bearing primary or secondary amino groups.

These additives are notable for their low ionic conductivity and their neutral pH compared with other surface-active additives.

Useful polyfunctional isocyanates (B22a) for preparing the additives (B22) are in particular diisocyanates, but compounds having three or four isocyanate groups can be used as well. Both aromatic and aliphatic isocyanates may be used.

Examples of preferred di- and triisocyanates are: 2,4-tolylene diisocyanate (2,4-TDI), 4,4′-diphenylmethane diisocyanate (4,4′-MDI), para-xylylene diisocyanate, 1,4-diisocyanatobenzene, tetramethyixylylene diisocyanate (TMXDI), 2,4′-diphenylmethane diisocyanate (2,4′-MDI) and triisocyanatotoluene and also isophorone diisocyanate (IPDI), 2-butyl-2-ethylpentamethylene diisocyanate, tetramethylene diisocyanate, hexamethylene diisocyanate, dodecamethylene diisocyanate, 2,2-bis(4-isocyanatocyclohexyl)propane, trimethylhexane diisocyanate, 2-isocyanatopropylcyclohexyl isocyanate, 2,4,4-trimethylhexamethylene diisocyanate, 2,2,4-trimethylhexamethylene diisocyanate, 2,4′-methylenebis(cyclohexyl)diisocyanate, cis-cyclohexane 1,4-diisocyanate, trans-cyclohexane 1,4-diisocyanate and 4-methylcyclohexane 1,3-diisocyanate (H-TDI).

It will be appreciated that mixtures of isocyanates (B22a) may also be used. There may be mentioned by way of example: mixtures of structural isomers of 2,4-tolylene diisocyanate and triisocyanatotoluene, examples being mixtures of 80 mol % of 2,4-tolylene diisocyanate and 20 mol % of 2,6-tolylene diisocyanate; mixtures of cis- and trans-cyclohexane 1,4-diisocyanate; mixtures of 2,4- or 2,6-tolylene diisocyanate with aliphatic diisocyanates, such as hexamethylene diisocyanate and isophorone diisocyanate.

Useful isocyanate-reactive organic compounds (B22b) preferably include compounds having at least two isocyanate-reactive hydroxyl groups per molecule. Compounds useful as (B22b), however, further include compounds having only one isocyanate-reactive hydroxyl group per molecule. These monofunctionalized compounds can partly or else wholly replace the compounds which comprise at least two isocyanate-reactive hydroxyl groups per molecule, in the reaction with the polyisocyanate (B22a).

Examples of particularly preferred isocyanate-reactive compounds (B22b) having at least two isocyanate-reactive hydroxyl groups per molecule will now be recited.

They are polyetherdiols, polyesterdiols, lactone-based polyesterdiols, diols and triols with up to 12 carbon atoms, dihydroxy carboxylic acids, dihydroxy sulfonic acids, dihydroxy phosphonic acids, polycarbonatediols, polyhydroxyolefins and polysiloxanes having on average at least two hydroxyl groups per molecule.

Useful polyetherdiols (B22b) include for example homo- and copolymers of C₂-C₄-alkylene oxides, such as ethylene oxide, propylene oxide and butylene oxide, tetrahydrofuran, styrene oxide and/or epichlorohydrin, which are obtainable in the presence of a suitable catalyst, an example being boron trifluoride. Further useful polyetherdiols are obtainable by (co)polymerization of these compounds in the presence of a starter having at least two acidic hydrogen atoms, examples of a starter being water, ethylene glycol, thioglycol, mercaptoethanol, 1,3-propanediol, 1,4-butanediol, 1,6-hexanediol, 1,12-dodecanediol, ethylenediamine, aniline or 1,2-di-(4-hydroxyphenyl)propane.

Examples of particularly suitable polyetherdiols (B22b) are polyethylene glycol, polypropylene glycol, polybutylene glycol and polytetrahydrofuran and also copolymers thereof.

The molecular weight Mₙ of the polyetherdiols is preferably in the range from 250 to 5000 and more preferably in the range from 500 to 2500.

Useful isocyanate-reactive compounds (B22b) further include polyesterdiols (hydroxy polyesters), which are common knowledge.

Preferred polyesterdiols (B22b) are the reaction products of diols with dicarboxylic acids or their reactive derivatives, examples being anhydrides or dimethyl esters.

Useful dicarboxylic acids include saturated and unsaturated aliphatic and also aromatic dicarboxylic acids which may bear additional substituents, such as halogen. Preferred aliphatic dicarboxylic acids are saturated unbranched α,ω-dicarboxylic acids comprising from 3 to 22 and in particular from 4 to 12 carbon atoms.

Examples of particularly suitable dicarboxylic acids are: succinic acid, glutaric acid, adipic acid, suberic acid, azelaic acid, sebacic acid, 1,12-dodecanedicarboxylic acid, maleic acid, maleic anhydride, fumaric acid, itaconic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, terephthalic acid, dimethyl terephthalate and dimethyl isophthalate.

Useful diols include in particular saturated and unsaturated aliphatic and cycloaliphatic diols. The aliphatic α,ω-diols which are particularly preferred are unbranched and have from 2 to 12, in particular from 2 to 8 and especially from 2 to 4 carbon atoms. Preferred cycloaliphatic diols are derived from cyclohexane.

Examples of particularly suitable diols are: ethylene glycol, propylene glycol, 1,3-propanediol, 1,4-butanediol, 2-methylpropane-1,3-diol, 1,5-pentanediol, neopentyl glycol, 1,6-hexanediol, 1,8-octanediol, 1,10-decanediol, 1,12-dodecanediol, cis-but-2-ene-1,4-diol, trans-but-2-ene-1,4-diol, 2-butyne-1,4-diol, cis-1,4-di(hydroxymethyl)-cyclohexane and trans-1,4-di(hydroxymethyl)cyclohexane.

The molecular weight Mₙ of the polyesterdiols is preferably in the range from 300 to 5000.

Lactone-based polyesterdiols useful as an isocyanate-reactive compound (B22b) are based in particular on aliphatic saturated unbranched ω-hydroxy carboxylic acids having from 4 to 22 and preferably from 4 to 8 carbon atoms. It is also possible to use branched ω-hydroxy carboxylic acids wherein one or more —CH₂— groups in the alkylene chain are replaced by —CH(C₁-C₄-alkyl)-.

Examples of preferred ω-hydroxy carboxylic acids are γ-hydroxybutyric acid and δ-hydroxyvaleric acid.

It will be appreciated that the abovementioned diols may likewise be used as isocyanate-reactive compounds (B22b), in which case the same preferences as above apply.

Triols, in particular triols having from 3 to 12 carbon atoms and especially triols having from 3 to 8 carbon atoms are likewise useful as isocyanate-reactive compounds (B22b). Trimethylolpropane is an example of a particularly suitable triol.

Dihydroxy carboxylic acids useful as isocyanate-reactive compounds (B22b) are in particular aliphatic saturated dihydroxy carboxylic acids which preferably comprise 4 to 14 carbon atoms. Dihydroxy carboxylic acids of the formula

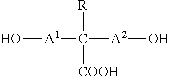

where A¹ and A² represent identical or different C₁-C₄— alkylene radicals and R represents hydrogen or C₁-C₄-alkyl, are very particularly suitable.

Dimethylolpropionic acid (DMPA) is a particularly preferred example of these dihydroxy carboxylic acids.

Useful isocyanate-reactive compounds (B22b) further include the corresponding dihydroxy sulfonic acids and dihydroxy phosphonic acids, such as 2,3-dihydroxypropanephosphonic acid.

Dihydroxy carboxylic acid as used herein shall also comprise compounds comprising more than one carboxyl function (or as the case may be anhydride or ester function). Such compounds are obtainable by reaction of dihydroxy compounds with tetracarboxylic dianhydrides, such as pyromellitic dianhydride or cyclopentanetetra-carboxylic dianhydride, in a molar ratio from 2:1 to 1.05:1 in a polyaddition reaction, and preferably have an average molecular weight Mₙ in the range from 500 to 10 000.

Examples of useful polycarbonatediols (B22b) are the reaction products of phosgene with an excess of diols, in particular unbranched saturated aliphatic α,ω-diols having from 2 to 12, in particular from 2 to 8 and especially from 2 to 4 carbon atoms.

Polyhydroxyolefins useful as an isocyanate-reactive compound (B22b) are in particular α,ω-dihydroxyolefins, and α,ω-dihydroxybutadienes are preferred.

Furthermore the polysiloxanes useful as an isocyanate-reactive compound (B22b) comprise on average at least two hydroxyl groups per molecule. Particularly suitable polysiloxanes comprise on average from 5 to 200 silicon atoms (number average) and are in particular substituted by C₁-C₁₂-alkyl groups, in particular methyl groups.

Examples of isocyanate-reactive compounds (B22b) comprising just one isocyanate-reactive hydroxyl group are in particular aliphatic, cycloaliphatic and araliphatic or aromatic monohydroxy carboxylic acids and monohydroxy sulfonic acids.

The polyurethane-based additives (B22) are prepared by reaction of the compounds (B22a) and (B22b) in a molar ratio of (B22a) to (B22b) which is generally in the range from 2:1 to 1:1 and preferably in the range from 1.2:1 to 1:1.2.

It is possible in this connection, as well as the aforementioned isocyanate-reactive compounds (B22b), to add further compounds having isocyanate-reactive groups, for example dithiols, thio alcohols, such as thioethanol, amino alcohols, such as ethanolamine and N-methylethanolamine, or diamines, such as ethylenediamine, to thereby prepare polyurethanes which, as well as urethane groups, additionally bear isocyanurate groups, allophanate groups, urea groups, biuret groups, uretidione groups or carbodiimide groups. Further examples of such isocyanate-reactive compounds are aliphatic, cycloaliphatic, araliphatic or aromatic carboxylic acids and sulfonic acids which bear at least two primary and/or secondary amino groups.

It will be appreciated that it is also possible to add corresponding compounds having just one isocyanate-reactive group, examples being monoalcohols, primary and secondary monoamines, monoamino carboxylic and sulfonic acids and mercaptans. Customary use levels range up to 10 mol %, based on (B22a).

Preferably, some or all of the carboxyl groups of the reaction products (B22) are in salt form in order that solubility in water may be ensured. Useful salts include for example alkali metal salts, such as sodium and potassium salts, and ammonium salts.

Typically, the additives (B22) have average molecular weights M_{w} in the range from 500 to 250 000.

Specific surface-active properties can be achieved for the additives (B22) by varying the ratio of polar to apolar groups.

Such anionic surface-active additives (B22) are known and commercially available, for example under the name Borchi® GEN SN95 (Borchers).

It will be appreciated that mixtures of a plurality of additives (B1) and also mixtures of a plurality of additives (B2) can be used.

Component (C) of the pigment preparations according to the present invention comprises an antioxidant.

The presence of the antioxidant (C) serves to stabilize the pigment preparations of the present invention for the drying step, so that they can be dried at technically sensible temperatures of ≧70° C. without risk of autoignition.

Although the antioxidants are famously water-insoluble compounds, they surprisingly do not impair the dispersibility of the pigment preparations of the present invention in aqueous media.

Examples of useful antioxidants (C) include the well known classes of the sterically hindered phenols, of the aromatic amines, of the thiosynergists, of the phosphites and phosphonites and of the sterically hindered amines.

Antioxidants based on sterically hindered phenol comprise, as an essential building block, a phenol substituted by at least one tert-butyl group ortho and in particular by tert-butyl groups in both ortho positions relative to the OH group. Most known products comprise a plurality of these building blocks, which are bonded to each other via various bridging members.

Antioxidants based on aromatic amines are mainly diarylamines, amine-ketone condensation products, for example aniline-acetone condensates, and substituted p-phenylenediamines.

Examples of thiosynergists are the metal salts of dialkyldithiocarbamic acids, zinc dialkyl dithiophosphates and esters (especially dilauryl, dimyristyl and distearyl esters) of thiodipropionic acid.

Antioxidants based on phosphites and phosphonites are typically the esters of the corresponding acids of phosphorus with alkyl-substituted, especially tert-butyl-substituted, phenols.

Antioxidants based on sterically hindered amines (HALS) comprise, as an essential building block, a 2,6-dialkyl-substituted, in particular a dimethyl-substituted, piperidine linked in position 4 to various piperidine building blocks via a wide range of bridging members.

Antioxidants are generally known and obtainable for example under the names of Irganox®, Irgaphos®, Chimassorb®® and Irgastab® (Ciba), Topanol® (ICI), Hostanox® (Clariant) and Goodrite® (Goodyear).

The pigment preparations of the present invention comprise 45% to 90% by weight of component (A), 5% to 50% by weight of component (B) and 0.1% to 5% by weight of component (C).

Preferably, the pigment preparations of the present invention comprise 55% to 90% by weight of component (A), 10% to 45% by weight of component (B) and 0.1% to 2% by weight of component (C), the sum total of said components (A), (B) and (C) not exceeding 100% by weight.

The pigment preparations according to the present invention are advantageously obtainable by the production process which is likewise according to the present invention by first wet-comminuting said pigment (A1) in aqueous suspension comprising said antioxidant (C) and some or all of said additive (B), if desired adding a filler (A2) to said suspension before or after said wet-comminuting of said pigment (A1) and then drying said suspension, if appropriate after the rest of said additive (B) has been added.

The pigment (A1) can be employed in the process of the present invention as a dry powder or in the form of a press cake.

The employed pigment (A1) is preferably a finished product, i.e., the primary particle size of the pigment has already been set to the desired value for the planned application. This pigment finish is especially advisable in the case of organic pigments, since the as-synthesized crude pigment is generally not directly suitable for the planned application. In the case of inorganic pigments, examples being oxide and bismuth vanadate pigments, the primary particle size can also be set in the course of the synthesis of the pigment, so that the pigment suspensions obtained can be employed directly in the process of the present invention.

Since the finished pigment (A1) typically reagglomerates again in the course of drying or on the filter assembly, it is subjected to wet comminution, for example grinding in a stirred media mill, in aqueous suspension.

The wet comminution should be carried out with some or all of the additive (B) comprised in the ready-produced pigment preparation; it is preferable to add the entire amount of additive (B) prior to the wet comminution.

To achieve a very homogeneous distribution of the antioxidant (C), it is advantageously also added prior to the wet comminution.

When a filler (A2) is used, it can be added before or after wet comminution. If already of the desired particle size distribution, it is preferably dispersed only after the wet comminution of the pigment (A1) in the pigment suspension. This is so particularly for soft fillers, such as chalk, which would suffer unwanted co-comminution during pigment grinding. Conversely, requisite comminution of too coarse-particled a filler can be combined advantageously with pigment comminution.

The particle size of the pigment preparations of the present invention can be controlled to a specifically targeted value, depending on the method which is chosen for drying-spray granulation and fluidized bed drying, spray drying, drying in a paddle dryer, evaporation and subsequent comminution.

Spray and fluidized bed granulation may produce coarsely divided granules having average particle sizes from 50 to 5000 μm and especially from 100 to 1000 μm. Spray drying typically produces granules having average particle sizes <20 μm. Finely divided preparations are obtainable by drying in a paddle dryer and by evaporation with subsequent grinding. Preferably, however, the pigment preparations of the present invention are in granule form.

Spray granulation is preferably carried out in a spray tower using a one-material nozzle. Here, the suspension is sprayed in the form of relatively large drops, and the water evaporates. The additives melt at the drying temperatures and so lead to the formation of a substantially spherical granule having a particularly smooth surface (BET values generally ≦15 m²/g, and especially ≦10 m²/g).

The gas inlet temperature in the spray tower is generally in the range from 180 to 300° C. and preferably in the range from 150 to 300° C. The gas outlet temperature is generally in the range from 70 to 150° C. and preferably in the range from 70 to 130° C.

The residual moisture content of the granular pigment obtained is preferably <5% by weight.

The pigment preparations of the present invention are notable in application media comprising a liquid phase for their excellent color properties which are comparable to those of liquid pigment formulations, especially with regard to color strength, brilliance, hue and hiding power, and in particular for their stir-in characteristics, i.e. they can be dispersed in application media with a minimal input of energy, simply by stirring or shaking. This applies in particular to the coarsely divided pigment granules, which constitute the preferred embodiment of the pigment preparations of the present invention.

Compared with liquid pigment formulations, the pigment preparations of the present invention additionally have the following advantages: they have a higher pigment content. Whereas liquid formulations tend to change viscosity during storage and have to be admixed with preservatives and agents for enhancing the resistance to freezing and/or drying out (crusting), the pigment preparations of the present invention exhibit very good stability in storage. They are both economically and ecologically advantageous with regard to packaging, storage and transportation. Since they are solvent free, they are more flexible in use.

The pigment preparations of the present invention which are in granule form are notable for excellent attrition resistance, a minimal tendency to compact or clump, uniform particle size distribution, good pourability, flowability and meterability and also dustlessness in handling and application.

The advantageous qualities above are shared by said preparations with their above-described counterparts having stir-in characteristics, which comprise pigments and surface-active additives but no fillers. They score additionally over said pigment preparations in their particularly effective adaptability to the intended application medium, given the absence of restrictions on the combination of pigments and additives. Thus due to the filler's presence even hydrophobic pigments, for example, such as carbon black can be combined with anionic surface-active additives and so used advantageously in aqueous application media too—aqueous basecoats, for example. The present invention's pigment preparations can also be used with particular ease for shading, the filler's diluent effect making them especially easy to meter. Lastly, they comprise the fillers in an extremely homogeneously distributed form and hence are markedly superior to the usual pigment/filler mixtures.

The pigment preparations of the present invention are very useful for coloration of macromolecular organic and inorganic materials of any kind. Liquid application media in this context can also be purely aqueous; comprise mixtures of water and organic solvents, for example alcohols; or be based exclusively on organic solvents, such as alcohols, glycol ethers, ketones, e.g. methyl ethyl ketone, amides, e.g. N-methyl-pyrrolidone and dimethylformamide, esters, e.g. ethyl acetate, butyl acetate and methoxypropyl acetate, or aromatic or aliphatic hydrocarbons, e.g. xylene, mineral oil and mineral spirits.

If desired, the preparations can initially be stirred into a solvent which is compatible with the particular application medium, and this stirring into the solvent is again possible with minimal input of energy, and then be introduced into this application medium. For instance, slurries of pigment preparations in glycols or other solvents customary in the paint and coatings industry, such as methoxypropyl acetate, can be used to render the pigment preparations adapted to aqueous systems compatible with hydrocarbon-based systems or systems based on nitrocellulose.

Examples of materials which can be colored with the pigment preparations of the present invention include: coatings, for example architectural coatings, industrial coatings, automotive coatings, radiation-curable coatings; paints, including paints for building exteriors and building interiors, for example wood paints, lime washes, distempers, emulsion paints; solventborne printing inks, for example offset printing inks, flexographic printing inks, toluene gravure printing inks, textile printing inks, radiation-curable printing inks; waterborne inks, including inkjet inks; color filters; building materials (water is typically added only after building material and granular pigment have been dry-mixed), for example silicate render systems, cement, concrete, mortar, gypsum; bitumen, caulks; cellulosic materials, for example paper, paperboard, cardboard, wood and woodbase, which can each be coated or otherwise finished; adhesives; film-forming polymeric protective colloids as used for example in the pharmaceutical industry; cosmetic articles; detergents.

The pigment preparations of the present invention are also very useful for coloring plastics of all kinds. The following classes and types of plastics may be mentioned here by way of example:
modified natural materials:
thermosets, e.g. casein plastics; thermoplastics, e.g. cellulose nitrate, cellulose acetate, cellulose mixed esters and cellulose ethers;
synthetic plastics:
polycondensates: thermosets, e.g. phenolic resin, urea resin, thiourea resin, melamine resin, unsaturated polyester resin, allylic resin, silicone, polyimide and polybenzimidazole; thermoplastics, e.g. polyamide, polycarbonate, polyester, polyphenylene oxide, polysulfone and polyvinyl acetal;
addition polymers: thermoplastics, e.g. polyolefins, such as polyethylene, polypropylene, poly-1-butene and poly-4-methyl-1-pentene, ionomers, polyvinyl chloride, polyvinylidene chloride, polymethyl methacrylate, polyacrylonitrile, polystyrene, polyacetal, fluoropolymers, polyvinyl alcohol, polyvinyl acetate and poly-p-xylylene and also copolymers, such as ethylene-vinyl acetate copolymers, styrene-acrylonitrile copolymers, acrylonitrile-butadiene-styrene copolymers, polyethylene glycol terephthalate and polybutylene glycol terephthalate;
polyadducts: thermosets, e.g. epoxy resin and crosslinked polyurethanes; thermoplastics, e.g. linear polyurethanes and chlorinated polyethers.

Advantageously, plastics are colorable with the pigment preparations of the present invention by minimal energy input, for example by conjoint extrusion (preferably using a single- or twin-screw extruder), rolling, kneading or grinding. The plastics can be present at that stage as plastically deformable masses or melts and be processed into moldings, films and fibers.

The pigment preparations of the present invention are also notable in plastics coloration for altogether advantageous application properties, especially for good color properties, in particular high color strength and brilliance, and the good rheological properties of the plastics which have been colored with them, especially for low pressure-filter values (high filter lifetimes) and good spinnability.

### EXAMPLES

### Production and Testing of Inventive Pigment Preparations

The pigment preparations were produced by ball milling a suspension of x g of finished pigment (A1), y g of additive (B1) and z g of antioxidant (C) in 150 g of water (in the case of pH values <7, adjusted to pH 7 by addition of 25% by weight aqueous sodium hydroxide solution) to a d₅₀ value of <1 μm and then dried in a circulating air drying cabinet at 60° C.

To investigate the drying characteristics of the pigment preparations according to the present invention, their onset temperature was determined.

The onset temperature is that heating temperature at which the temperature of a substance being heated in an airstream exceeds the temperature of an inert reference substance heated in the same airstream. To ensure safe drying in manufacture (no autoignition), the drying temperature should be about 50° C. below the onset temperature.

To determine the onset temperature, a 10 cm³ sample of the respective pigment preparation and of graphite as reference sample was heated at a heating rate of 1° C./min in a 2 l/min airstream while the temperature of the two samples was monitored.

In addition, the pigment preparations of the present invention were subjected to a coloristic test. In this, they exhibited color strengths comparable to those of the respective analogous commercially available aqueous formulations.

The table hereinbelow lists the compositions of the pigment preparations produced and also their respective determined onset temperatures. The onset temperatures of the respective pigment preparations comprising no antioxidant are reported for comparison. The additive (B1) and antioxidant (C) used were as follows:
(B1): PO-EO block copolymer having central PO block (E0 content: 50% by weight; Mₙ: 6500)
(C1): Irganox® 1010 (Ciba) (tetrakis[methylene(3,5-di(tert-butyl)-4-hydroxyhydro-cinnamate)]methane)
(C2): Irganox 1076 (Ciba) (octadecyl 3,5-di-(tert-butyl)-4-hydroxyhydroycinnamate)
(C3): Irgafos® 168 (Ciba) (tris[2,4-di(tert-butylphenyl)phosphite)

TABLE

| | | | Additive | | | Onset |
|---|---|---|---|---|---|---|
| | Pigment | | (B1) | Antioxidant | | temp. |
| Ex. | x g | (A1) | y g | z g | (C) | [° C.] |
| inv 1* | 84 | Yellow 42 (opaque) | 15 | 1 | (C1) | 194 |
| comp 1 | 85 | Yellow 42 (opaque) | 15 | — | — | 125 |
| inv 2** | 58 | Yellow 42 (transp.) | 40 | 2 | (C1) | 185 |
| comp 2 | 60 | Yellow 42 (transp.) | 40 | — | — | 110 |
| inv 3*** | 79 | Red 101 (opaque) | 20 | 1 | (C1) | 205 |
| comp 3 | 80 | Red 101 (opaque) | 20 | — | — | 94 |
| inv 4 | 79 | Yellow 184 | 20 | 1 | (C1) | 294 |
| comp 4 | 80 | Yellow 184 | 20 | — | — | 160 |
| inv 5 | 79 | Black 11 | 20 | 1 | (C1) | 188 |
| inv 6 | 79 | Black 11 | 20 | 1 | (C2) | 178 |
| inv 7 | 79 | Black 11 | 20 | 0.5 | (C1) | 178 |
| | | | | 0.5 | (C3) | |
| inv 8 | 79 | Black 11 | 20 | 0.5 | (C1) | 180 |
| | | | | 0.5 | (C2) | |
| comp 5 | 80 | Black 11 | 20 | — | — | 150 |

*BET surface area 13 m²/g (Bayferrox ® Gelb 920 (Lanxess))
**BET surface area 90 m²/g (Sicotrans ® Gelb 1916 (BASF))
***BET surface area 6 m²/g (Bayferrox Rot 130 (Lanxess))

We claim:

1. A solid pigment preparation comprising as essential constituents
(A) 45% to 90% by weight of at least one color-conferring component comprising
(A1) 5% to 100% by weight of at least one pigment and
(A2) 0% to 95% by weight of at least one filler without self color,
(B) 5% to 50% by weight of at least one water-soluble surface-active additive from the group of alkylene oxide group containing additives (B1) and alkylene oxide group free additives (B2), the alkylene oxide group containing additive (B1) comprising at least 5% by weight of the pigment preparation, and
(C) 0.1% to 5% by weight of an antioxidant.

2. The pigment preparation according to claim 1 wherein said component (A1) comprises at least one inorganic pigment.
